(19) United States
(12) Patent Application Publication
(10) Pub. No.: US 2005/0016390 A1
(43) Pub. Date: Jan. 27, 2005

(54) Adornment and method of making adornment

(75) Inventor: Katherine Waymire, Minneapolis, MN (US)

Correspondence Address: BOYLE FREDRICKSON NEWHOLM STEIN&GRATZ;INTELLECTUAL PROPERTY LAW, SUITE 1030, 250 EAST WISCONSIN AVENUE, MILWAUKEE, WI, 53202, US

(73) Assignee: Talisman Designs, LLC

(21) Appl. No.: 10/606,273

(22) Filed: Jun. 24, 2003

Related U.S. Application Data
(60) Provisional application No. 60/391,286, filed on Jun. 24, 2002.

(51) Int. Cl. A23L 1/00

(52) U.S. Cl. 99/485

(57) ABSTRACT

An adornment that comprises a helical segment that snaps onto the stem of a wine glass, some other stemware, or receives and releasably retains a napkin therein. In a preferred embodiment, the helical segment is comprised of wire having a composition and thickness that retains its shape memory upon being preformed such that it will repeatedly snap on and off a stem or receive and release a napkin. The wire can be German-type jewelry wire having a thickness of eighteen gauge or greater and can carry a plurality of indicias. In one preferred embodiment, the segment has a head at each end that engages or bears against the stem or napkin when the adornment is attached to the stem or napkin. A preferred method of making includes forming the segment around a generally cylindrical mandrel that preferably is grooved, and gluing each head adjacent or at an end using a low blooming adhesive.

### CROSS REFERENCE TO RELATED APPLICATION

This application claims the benefit of U.S. Provisional Patent Application No. 60/391,286, filed Jun. 24, 2002, under 35 U.S.C. §119(e), the entirety of which is incorporated by reference herein.

### FIELD OF THE INVENTION

The present invention relates to an adornment and more particularly to a memory shape retaining adornment that releasably receives an article such as a stem of a piece of stemware or a napkin, and a method of making such an adornment.

### BACKGROUND OF THE INVENTION

Past attempts to make wine charms and stemware adornments have proven unsatisfactory because they generally do not last long, easily fall off, or break because of fatigue. What is needed is an adornment that is more durable, more versatile, and which is more stably retained on a stemware stem or a napkin.

### SUMMARY OF THE INVENTION

An adornment that includes a helical segment that is releasably received and remains retained on an object, that preferably is a stem of a wine glass, some other stemware, or a napkin or the like. The adornment preferably comprises a preformed helical segment that is constructed and arranged to snap onto the stemware stem, wraparound the object, or receive the object and remain wrapped around by its wrap around shape. It preferably includes at least one means for uniquely identifying the adornment that can comprise an indicia that is attached or mounted to the segment.

One preferred adornment construction includes a helical segment of wire that has a head at each end that snaps onto the stem such that each head comes into contact with part of the stem. The arrangement forms a cradle that is releasably retained on the stem. The helical shape is retained after repeated use such that the adornment can be used over and over again without fatiguing and breaking, without easily falling off of the stem after attachment, and without its constituent pieces coming apart.

Another preferred adornment construction includes a helical segment of wire that carries a plurality of objects, such as beads, balls, or the like, which are decorative and can comprise indicia. The adornment forms a generally helical cradle of wraparound construction that receives and retains an object that preferably is a piece of fabric, namely a napkin or the like. If desired, the segment can have a head at each end that facilitates receipt of the fabric piece.

In one preferred method, a segment of wire is wrapped around a generally cylindrical mandrel to perform it. A plurality of components is attached using an adhesive. The mandrel can have a helical groove in which the wire becomes seated during forming to help impart to it a desired helical configuration. Preferably, the forming step also imparts to the preformed segment a shape memory so it retains its helical shape during repeated use. Where the wire is comprised of metal or is of metallic construction, the adhesive preferably is a low blooming adhesive to prevent discoloration of the wire. Each head, as well as any indicia, can comprise a bead that can be made of a plastic, preferably acrylic.

Objects, features and advantages include one or more of the following: an adornment that snaps on and off a stemware stem; an adornment that receives and retains a napkin; an adornment that retains its shape after repeated use; an adornment of shape memory construction; an adornment that releasably attaches to a stemware stem but which is not easy to remove during use; and an adornment that is durable, resilient, washable, long lasting, of economical construction, which is of elegant construction, inexpensive to make, easy to use, and simple to maintain.

### BRIEF DESCRIPTION OF THE DRAWINGS

Preferred exemplary embodiments of the invention are illustrated in the accompanying drawings in which like reference numerals represent like parts throughout and in which:

FIG. 1 illustrates an elevation view of one preferred adornment embodiment received on a stem of a glass;

FIG. 2 is an enlarged perspective view of the adornment shown in FIG. 1;

FIG. 3 is an enlarged perspective view of a second preferred embodiment of a stemware adornment;

FIG. 4 is an enlarged perspective view of a third preferred stemware adornment;

FIG. 5 is an enlarged perspective view of a fourth preferred embodiment of a stemware adornment;

FIG. 6 is a perspective view of one preferred package for holding a plurality of the adornments;

FIG. 7 is an exploded view of the packaging shown in FIG. 6 depicting the packaging components in more detail;

FIG. 8 is an exploded view of a plurality of adornments, an adornment holder, and a display card of the packaging shown in FIGS. 6 and 7;

FIG. 9 is a perspective view of some materials and tools used to make an adornment of the invention;

FIG. 10 is a perspective view of one preferred glue used to make an adornment along with a plurality of adornments made using the glue;

FIG. 11 is an enlarged perspective view of a shaping mandrel used to form a portion of an adornment;

FIG. 12 is a fragmentary enlarged perspective view of the mandrel depicting its use in shaping a portion of an adornment being constructed;

FIG. 13 is another fragmentary enlarged perspective view of the mandrel shown in FIG. 12 rotated to provide a different view of the portion of the adornment being made;

FIG. 14 is an enlarged perspective view depicting a helical segment portion of the adornment after being formed using the mandrel;

FIG. 15 is an enlarged perspective view of the formed portion of the adornment being manufactured rotated to show a different view;

FIG. 16 is an enlarged perspective view of the adornment after attachment of indicia;

FIG. 17 is an enlarged perspective view of another preferred adornment attached to a fabric napkin; and

FIG. 18 is an enlarged perspective view of another preferred adornment embodiment depicted cradling a swath of flexible material.

### DETAILED DESCRIPTION OF AT LEAST ONE PREFERRED EMBODIMENT

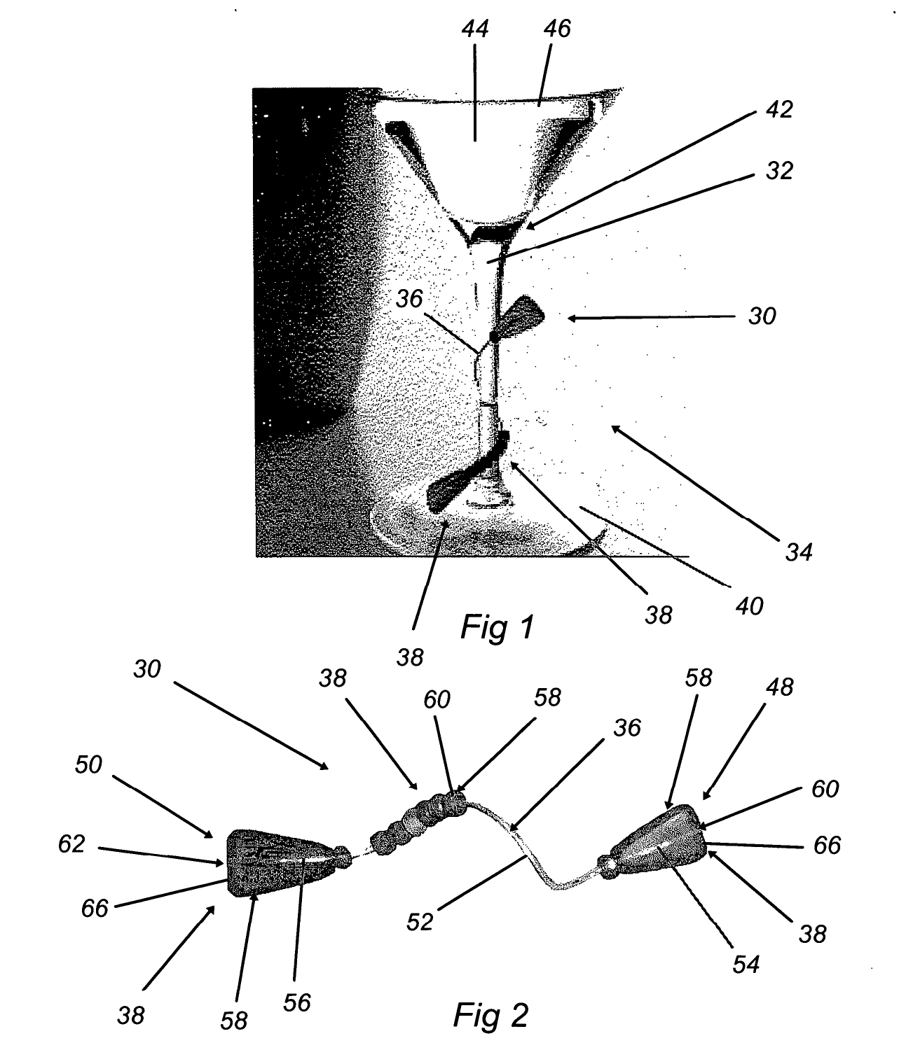

FIG. 1 illustrates an adornment 30 of this invention that is received on a stem 32 of a piece of stemware 34, such as a wine glass or the like. The adornment 30 includes a cradle 36 constructed and arranged to receive and cradle an object, in this case a stemware stem 32, in a manner in which the adornment stays on the object such that the object is cradled by the adornment. In the preferred adornment embodiment shown in FIG. 1, the adornment 30 is of wraparound construction such that it preferably has a generally helical shape constructed and arranged to snap onto a stemware stem 32.

The piece of stemware 34 shown in FIG. 1 is a wine glass that has a foot 40 at its bottom that serves as a pedestal upon which the glass rests. The stem 32 is generally cylindrical and extends upwardly from the foot 40. The stem 32 terminates at a bowl 42 in which liquid, such as wine, can be received. The bowl 42 comprises a head 44 that is a generally endless and annular sidewall that terminates in a top lip or rim 46. Such stemware preferably is made of glass, plastic or another material.

The adornment 30 includes a stem cradle 36 constructed and arranged to enable the adornment 30 to be releasably received and retained on the stem 32. In one preferred construction, the cradle 36 is formed so as to facilitate snapping or clipping of the adornment 30 onto a stem 32. The cradle 36 preferably is preformed and substantially rigid yet somewhat flexible so as to expand or flex at least slightly to accommodate such a stem 32 as the adornment 30 is being clipped thereon. By being substantially rigid and yet resilient, the cradle 36 can also slightly flex to permit the adornment 30 to be easily removed from the stem 32. A stemware adornment 30 equipped with a stem cradle 36 of the invention preferably comprises a clip that releasably snaps onto the stem 32 of a piece of stemware 34.

While being carried by a stem 32, the substantially rigid or shape memory retaining nature of the cradle 36 prevents sagging or other undesired deformation from occurring while on the stem 32. As a result, an adornment 30 of the invention remains coiled uprightly around a portion of the axial length of a stem during use. The cradle 36 thus functions as a supporting spine or frame for the adornment 30 such that the adornment is self-supporting and retains its shape during use and storage enabling repeated use.

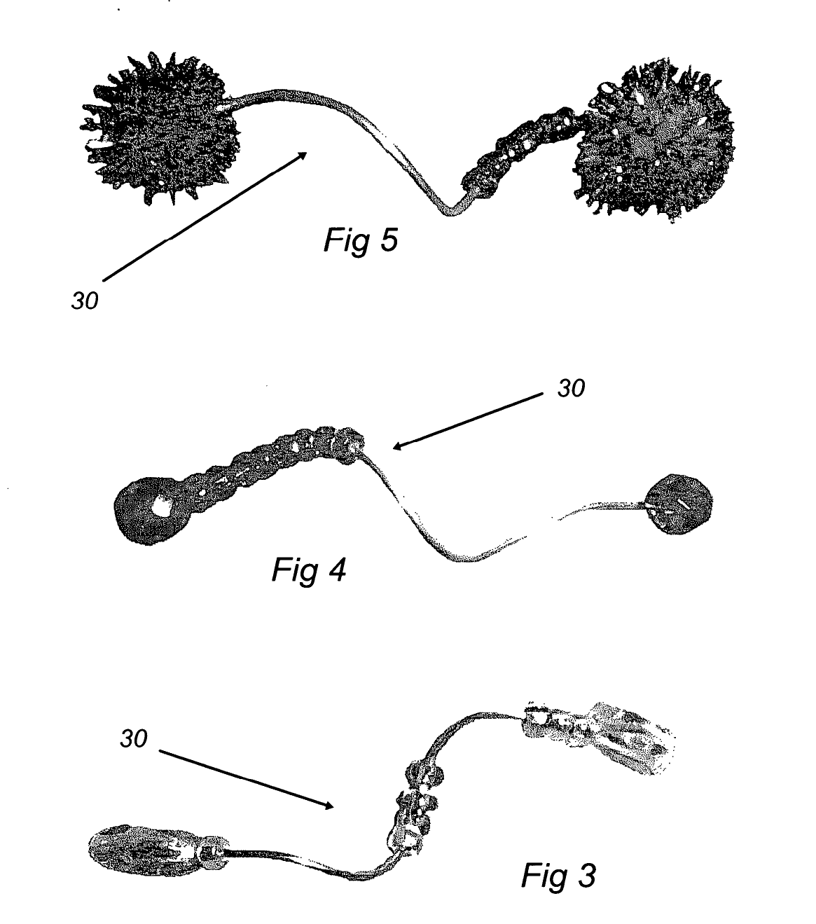

In the preferred adornment embodiments depicted in FIGS. 2-5, the stem cradle 36 has a curvilinear contour that preferably is of wraparound construction. Preferably, the cradle 36 is of a generally helical shape. As is shown in FIG. 1, when mounted to a stem 32, the cradle 36 wraps completely around the stem 32 at least one revolution, i.e., at least 360 degrees, or at least one turn. Preferably, the cradle 36 wraps around a stem 32 between one and one and a half times, i.e., between 360 degrees and 550 degrees, or between one turn and one and one half turns.

In one preferred embodiment, the adornment 30 is constructed so as to coil itself between one turn and one and a quarter turns around the stem 32 and has an axial length such that one end 48 is axially spaced at least one inch from its other end 50. Such an arrangement assures that the adornment 30 will wrap around the stem 32 along at least a third of the axial length of the stem 32 upon which the adornment is mounted. In a preferred embodiment, the adornment 30 has an axial length of at least two inches so as to wrap around at least about one half the axial length of the stem 32.

The cradle 36 preferably comprises a filament 52 that preferably is wire. Where single filament wire 52 is used, the wire has a thickness of no less than 0.038 inch to help ensure it will be stiff enough, yet pliable enough, to be preformed into a wraparound shape that will facilitate mounting and releasable retention of the adornment 30 onto a stem 32 of a piece of stemware 34. In one preferred embodiment, the wire 52 has a diameter of at least 0.045 inch or thicker and preferably is 18 gauge or thicker.

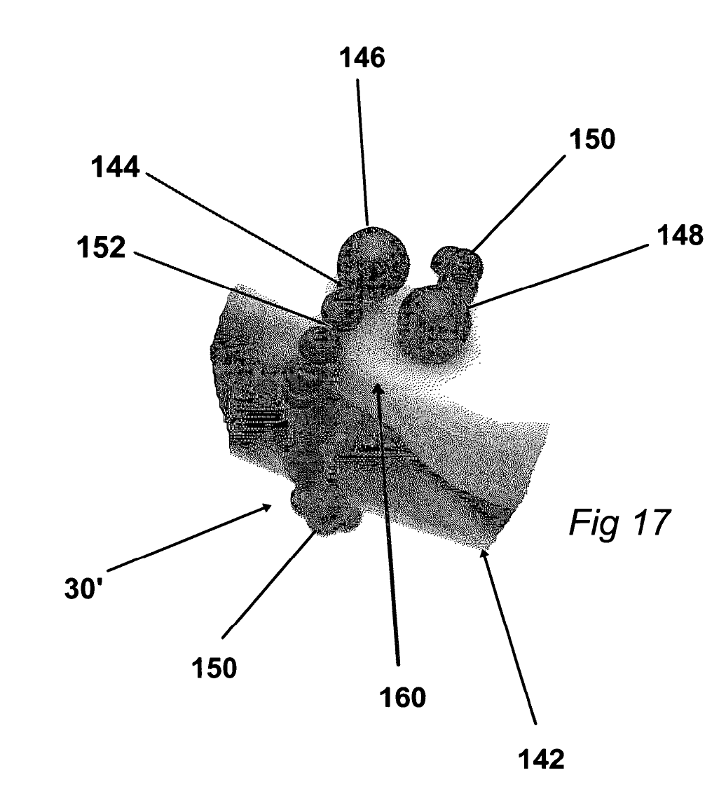

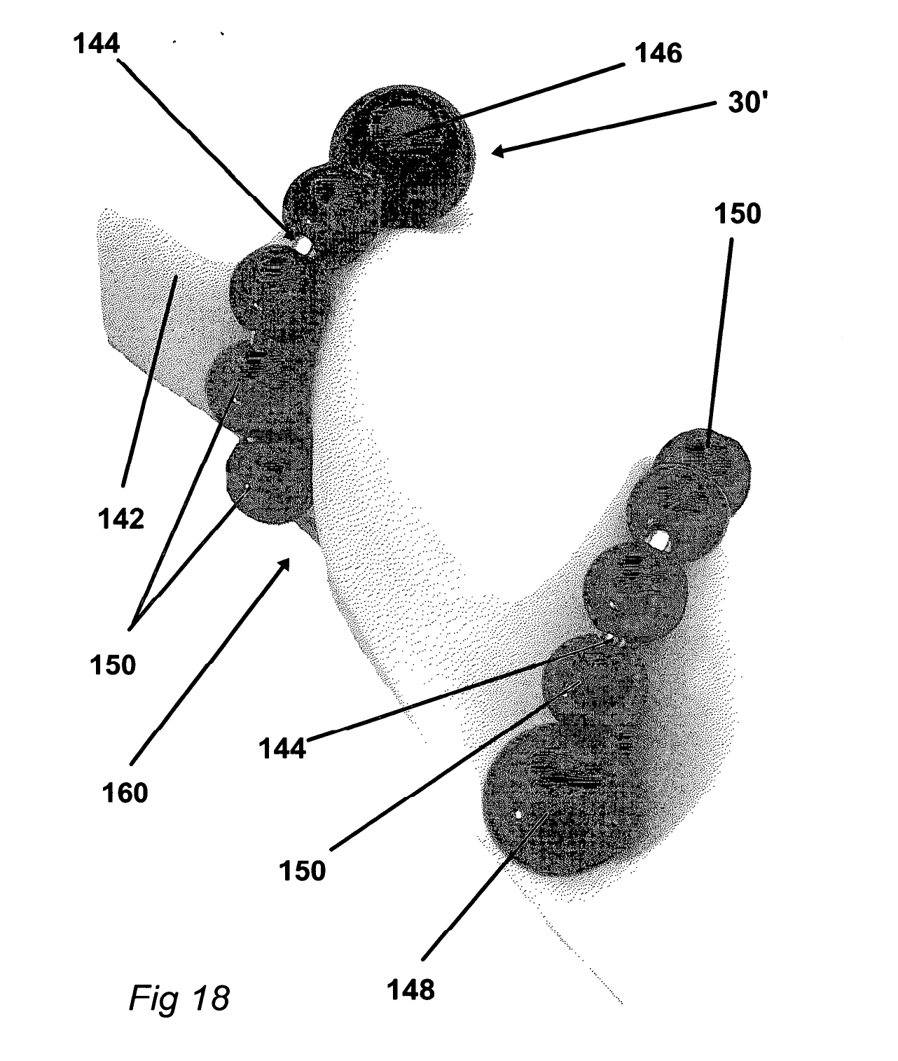

In one preferred embodiment, the wire is a jewelry grade wire that preferably is German-type jewelry wire or the like. A suitable wire 52 is comprised of metal, preferably copper, that preferably is coated or filled with silver or gold. Where a silver coating or filling is used, the silver preferably is sterling silver so as to minimize tarnishing and to make the adornment easy to clean or shine. The type of wire 52 selected preferably has at least some shape memory to substantially retain its preformed wraparound shape. As is shown in FIGS. 2-5, a preferred wraparound shape is generally helical.

Where a generally helical shape is employed, each cradle end preferably comprises a generally straight leg 54 and 56. In a preferred cradle embodiment shown in more detail in FIGS. 17 and 18, the cradle 36 is preformed into a spiral with one of the legs 54 disposed between an angle relative to a central cradle axis generally parallel to the other one of the legs 56 and an angle that is parallel to the axis and each other such that the legs 54 and 56 directly extend away from each other. Such an arrangement helps increase the amount of contact surface area between the adornment 30 and the stem 32 to increase adornment retention force and to help minimize movement of the adornment 30 during use. This, in turn, minimizes adornment wear and cradle stress cycling such that unwanted deformation is minimized. As a result, an adornment 30 constructed in accordance with the invention will keep its shape longer making it more durable and long-lasting.

A plurality of indicia 38 are carried by the stem cradle 36. Each indicia 38 helps make the adornment 30 unique so as to help identify who is using or owns the piece of stemware 34 on which the adornment 30 is mounted. In one preferred embodiment, each indicia 38 comprises a decorative piece 58 that is captured on the stem cradle 36. In one preferred embodiment, at least one of the decorative pieces 58 are movable relative to the cradle 36 so as to add a visually pleasing moving element to the adornment 30 during glass movement. In a preferred embodiment, one or more decorative pieces 58 comprise beads 60 that each have a bore therethrough through which a portion the stem cradle 36 is received.

Each adornment preferably also has a pair of heads 62 and 64 with one head 62 disposed at one end of the stem cradle 36 and the other head 64 disposed at the other end of the cradle. If desired, each head 62 and 64 can be part of the cradle 36 or can be integrally formed with the cradle. For example, although not shown, each cradle leg 54 and 56 can be formed with a turnback or the like that serves as a head. In the preferred embodiments shown in FIGS. 2, 4, 6, and 8, each head 62 and 64 comprises a cap 66 that receives at least part of one of the legs 54 and 56 of the cradle 36. Preferably, each cap 66 is comprised of plastic, glass, wood, ceramic, clay, stone, gem, metal, silver, gold, rhinestone, or another material that has a pocket therein to receive one end of a cradle.

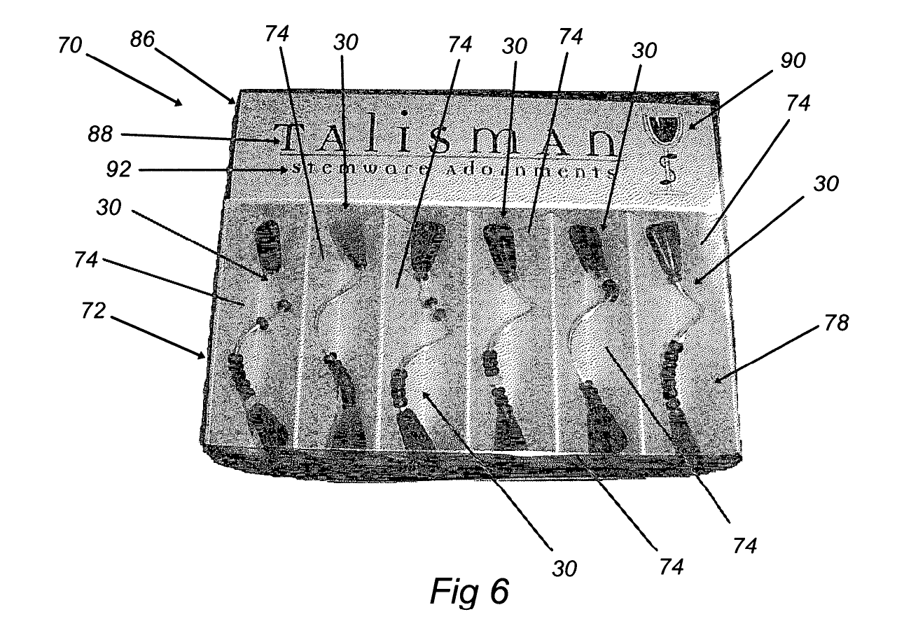

FIGS. 6-8 illustrate one preferred display package 70 of the invention that holds a plurality of the adornments 30 in a manner that permits their display such as when located on a shelf or table of a seller. The package 70 includes an adornment carrier 72 that has a plurality of pairs of adornment receiving pockets 74 and a cover 76 that preferably is at least partially transparent such that a prospective purchaser can view at least one of the adornments 30. Preferably, the cover 76 is constructed such that substantially all of the adornments 30 disposed at the top level of the package 70 can be viewed. In a preferred embodiment, the cover 76 preferably is comprised of a clear plastic that provides a viewing window 78 that enables viewing of each and every adornment 30.

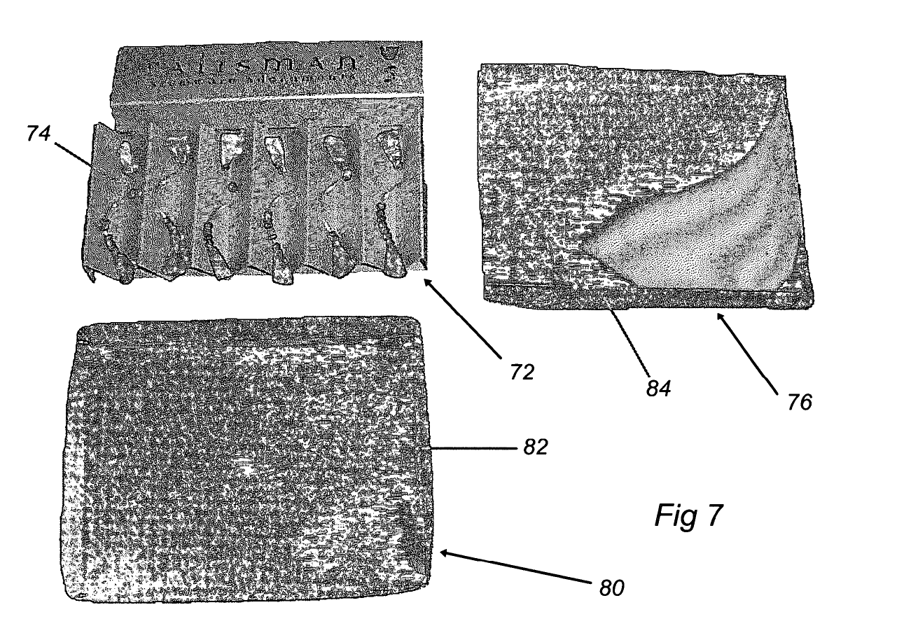

As is shown in FIG. 7, the package 70 also includes a bottom 80 that can also be made of a clear plastic in the same manner as the cover 76. The bottom 80 has sidewalls 82 designed to nest interiorly of the sidewalls 84 of the cover 76.

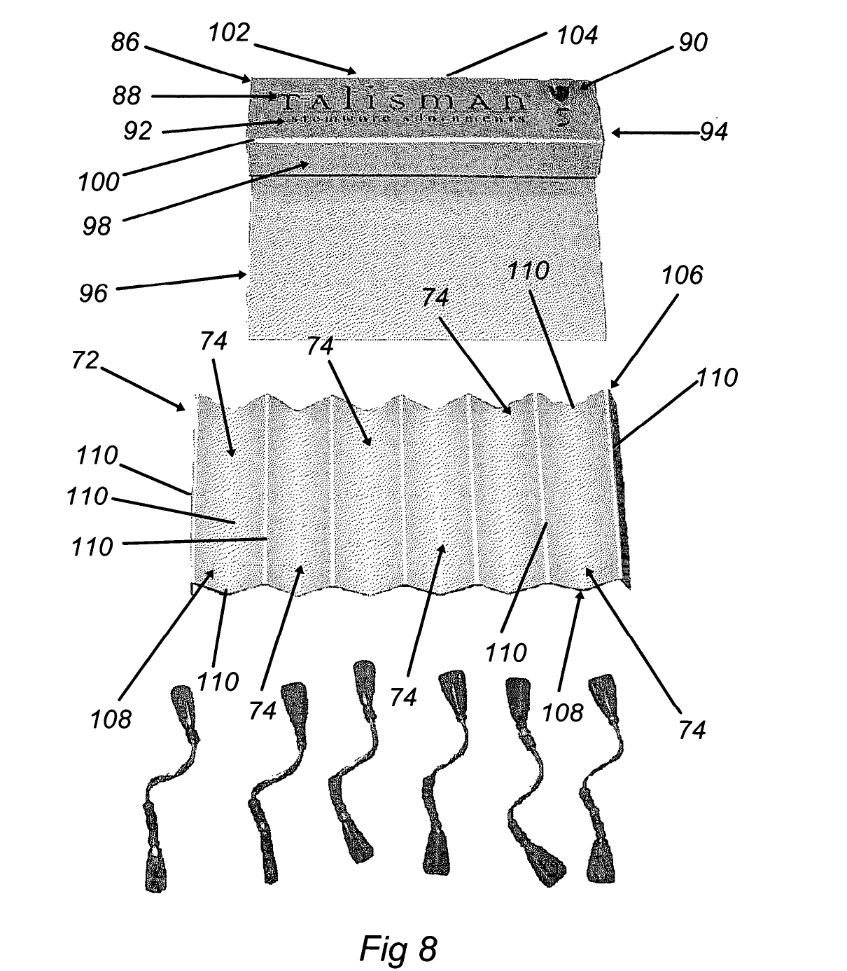

Referring more specifically to FIG. 8, the package 70 preferably also includes a product description panel 86 that can include a brand designation 88, a logo 90, a description 92, and, if desired, a blurb (not shown) and instructions (not shown). The product description panel 86 is part of a spacer 94 that is of a generally square or rectangular cross-section and that has a flap 96 that extends outwardly therefrom to underlie the adornment carrier 72. The spacer 94 preferably has four panels, with one of the panels being the product description panel 86, a front panel 98 that is separated by a fold 100 from the product description panel 86 such that it is disposed at a right angle to the panel 86, a top panel 102 separated by another fold 104 from the product description panel 86 such that it also is disposed at a right angle to it, and the flap 96 forming the fourth panel that is separated by a fold (not shown) from the top panel 102 so as to extend from the top panel at a right angle such that it is generally parallel to the product description panel 86. In a preferred embodiment, the spacer 94 can be made of plastic or another material.

The adornment carrier 72 has a pocket 74 for each adornment 30 received in the package. In a preferred embodiment, each pocket 74 is generally vee-shaped or triangular and has a length at least slightly greater than the axial length of the adornment. The carrier 72 is formed of a single panel 106 that is comprised of a plurality of bellows 108 defined by pleats 110 that collectively define adornment-receiving pockets 74. In a preferred embodiment, the carrier 72 is formed of a single pleated paper panel. If desired, plastic or another material can be used.

In one currently preferred package embodiment 70, the packages insert is of one-piece construction that includes the adornment carrier 72 and panel 86. The insert can be of one-piece and unitary construction. In another preferred embodiment, at least one of the adornment carrier 72 and panel 86 is fixed, such as by an adhesive or the like, to an underlying backing that can be flap 96.

FIGS. 17 and 18 illustrate another preferred embodiment of an adornment 30′ of this invention that is used to cradle a napkin 142 therein that preferably is comprised of cloth, fabric or linen. The napkin adornment 30′ includes a helical segment 144 that is formed so as to overlap the napkin 142 along an axial direction in the manner shown in FIGS. 17 and 18. The napkin adornment 30′ has a head 146, 148 at each end that helps facilitate retention of the napkin 142 after being cradled in the adornment. Each head 146, 148 preferably is fixed to one end of the helical segment 144, such as by an adhesive. The helical segment 144 carries a plurality of aesthetically pleasing objects 150, such as beads, which can be fixed or movable along the segment. Preferably, the segment 144 is comprised of wire 152, preferably German-type jewelry wire or a wire comprised of aluminum, of a type, construction, and thickness like that or the same as discussed above. If desired, the wire can be coated or filled with another metal, such as, preferably silver or gold. Where a silver coating or filling is used, the silver preferably is sterling silver so as to minimize tarnishing and to make the adornment easy to clean or shine.

Each adornment is curled into a generally helical segment that forms a wraparound cradle 160 in which an article is releasably received and retained. Each fabric receiving adornment 30′ preferably has a thickness or diameter of at least 18 gauge. Preferably, each fabric receiving adornment is comprised of a segment of aluminum wire 152 that has a thickness or diameter of at least about 9 gauge (≈2.9 mm) and preferably at least 8 gauge (≈3.2 mm).

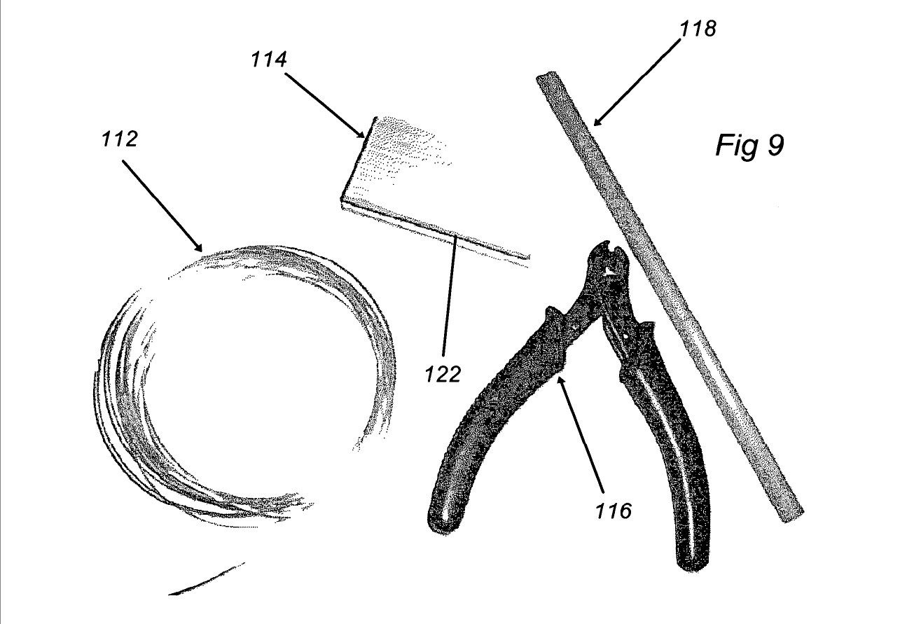

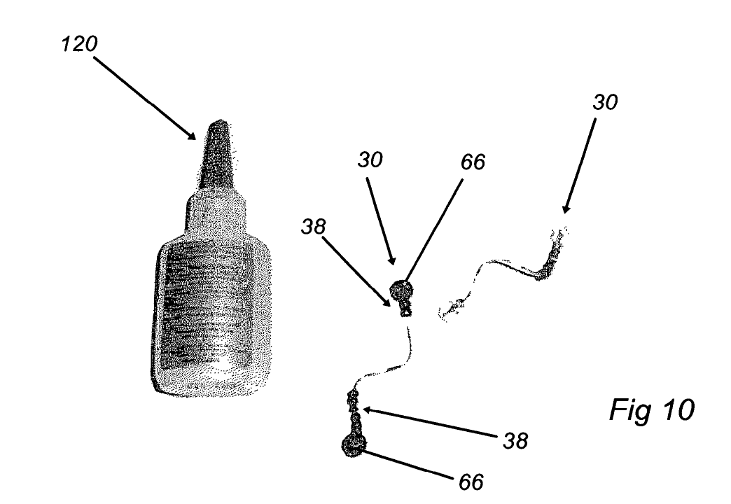

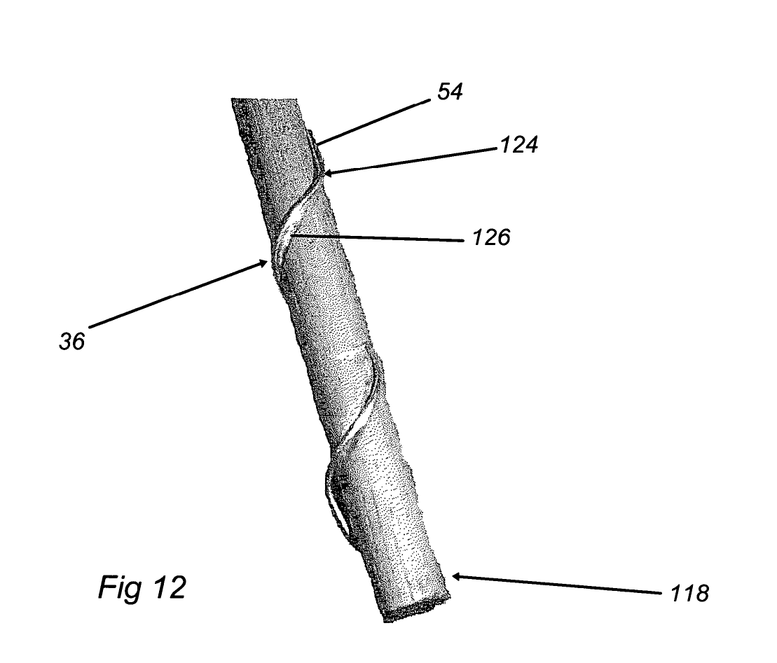

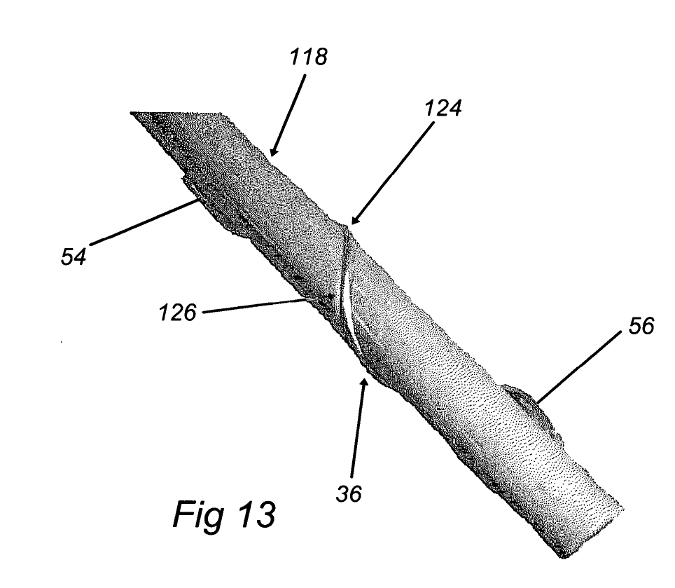

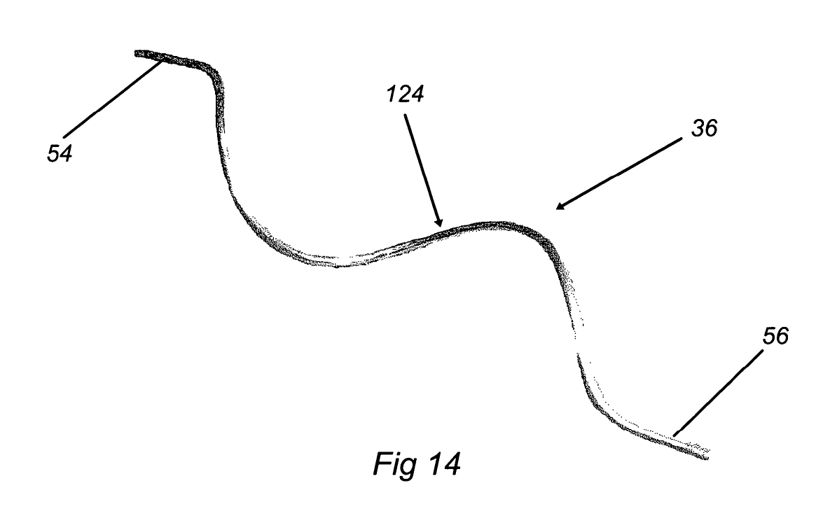

FIGS. 9-16 depict a preferred method of making an adornment 30 in according with the invention. FIG. 12 depicts a coil of wire 112 used to form a stem cradle 36, a measuring fixture 114 to measure an appropriate length of wire to cut, a cutter 116, preferably a pliers, used to cut a measured segment of wire, and a forming dowel 118 around which a cut segment of wire is wrapped. FIG. 13 depicts a pair of adornments 30 made using a preferred implementation of a method of the invention and a bottle of adhesive 120 used to attach indicia 38 and caps 66 to a segment of wire preferably after it has been formed and cut.

The coil of wire 112 is manipulated so as to separate a length that is wrapped around a portion of the measuring fixture 114. The fixture 114 is equipped with a wire-receiving groove 122 into which wire is disposed. The fixture 114 is used to measure a length of wire that preferably is no more than about three inches in length. The fixture 114 is made of wood but another material, such as plastic, could be used. With the wire in the fixture 114 so as to ensure the resultant cradle formed therefrom will have an acceptable length, the pliers 116 are manipulated to cut the wire 112, preferably at a location adjacent one corner of the fixture 114.

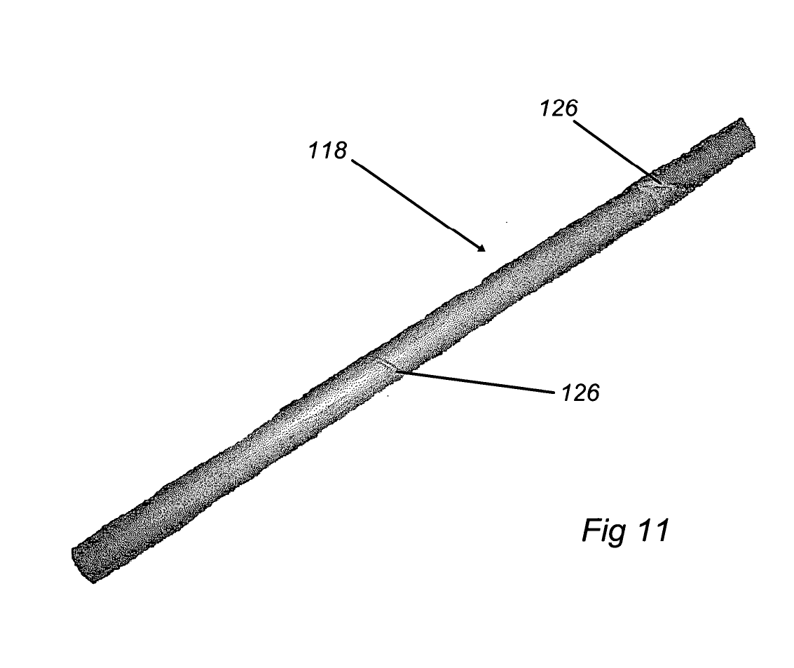

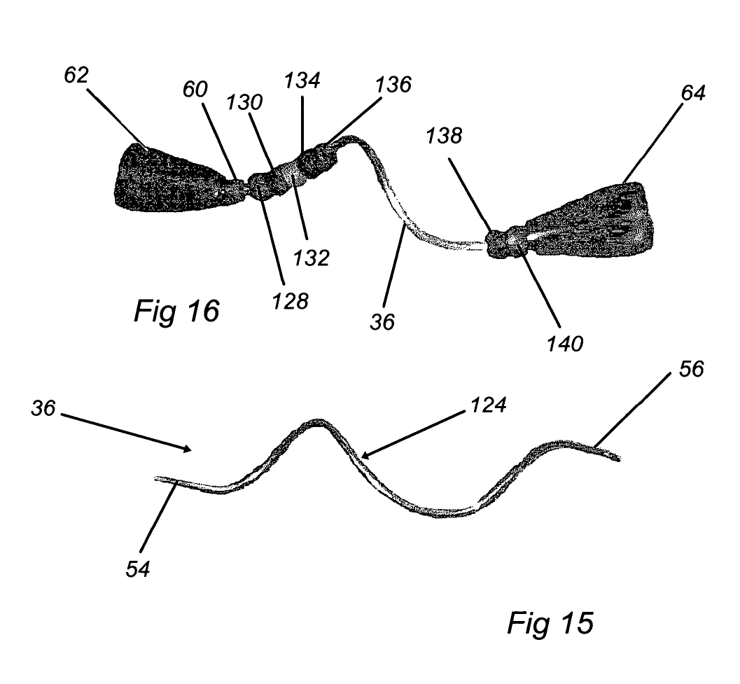

Referring more particularly to FIGS. 11-13, the cut segment of wire 124 is wrapped around the forming dowel 118 that preferably is generally cylindrical and has a diameter of between 5 millimeters and 10 millimeters so as to approximate a range of stem diameters about which a finished adornment 30 can be mounted. In a preferred embodiment, the dowel 118 has a diameter of about 9 millimeters and has a spiral wire-receiving channel 126 formed in a portion of its outer surface. The channel 126 has a depth no greater than 2 millimeters and preferably no greater than about 1 millimeter. As is shown in FIGS. 15 and 16, the cut wire segment 124 is wrapped around the dowel 118 and positioned such that it is received in the channel 126. The channel preferably is helical to form the wire segment 126 with a desired helical shape taking into account spring back and the like. Each end is bent at an angle relative to the channel 126 so as to form cradle legs 54 and 56 in the manner generally depicted in FIGS. 15 and 16.

In a preferred embodiment, the cradle 36 is preformed in such a manner so as to create an interference fit with a stem 32 of stemware 34. In a preferred embodiment, the cradle 36 is preformed so as to impart the adornment 30 with an interference fit when mounted to a stem 32 when equipped with heads 62 and 64. The interference fit preferably is a snap fit such that the cradle 36 or adornment 30 snaps onto a stem 32.

Referring to FIGS. 14-16, after forming, the wire segment comprises a stem cradle 36. Indicia 38, such as beads 60, are threaded onto the newly formed cradle 36. If desired, one or more indicia 38 can be immovably attached to the cradle 36. Where indicia 38 that can mounted so as to be movable relative to the cradle 36 are threaded onto the cradle 36, one head 62 preferably is mounted to an end of one of the legs 54. After all of the indicia 38 are received on the cradle 36, the other head 64 preferably is attached.

In a preferred method of attachment, both heads 62 and 64 are bonded to the cradle using an adhesive 120 that preferably is acrylic-based. One such preferred adhesive is cyanoacrylate glue. A preferred adhesive is a low blooming adhesive that preferably is a low blooming cyanoacrylate, such as low blooming super glue or a low blooming “CRAZY” glue. A low blooming adhesive advantageously dries clear and helps minimize white residue formation on the wire, each head, and any of the indicia that are bonded to the wire.

FIG. 16 illustrates an adornment 30 of the invention made with a preferred implementation of the aforementioned method. Wire is cut and formed into a helical stem cradle 36. Cyanoacrylate adhesive is applied to one end of a leg 54 of the cradle 36. The leg 54 is urged into a pocket in a head 62 such that the adhesive bonds the head 62 to the cradle 36. A first bead 60 is threaded onto the cradle 36 from the opposite end. The first bead 60 is slid along the cradle 36 until it is located adjacent head 62. Another drop or two of adhesive is applied to the cradle 36 adjacent the head 62 and the bead 60 is slid further into abutment against the head. The adhesive then bonds the bead 60 to the cradle 36 helping to provide reinforcement to the cradle 36 in the vicinity of the head 62 to reduce bending and cradle failure such as due to fatigue cracking or the like. A plurality of pairs of beads, i.e., at least three, such as beads 128, 130, 132, 134, 136, 138, and 140, are then threaded onto the cradle 36, but not bonded. The second head 64 is mounted on the other leg 56 and bonded to the cradle 36 using adhesive. One of the beads 140 is then bonded to the cradle 36 in abutment against the second head 64.

In use, a stemware adornment 30 of the invention is grasped and maneuvered against a stem 32 of a piece of stemware 34 such that each head 62 and 64 is in contact with the stem 32 at an initial point of contact. At this point in a method of mounting the adornment 30 to a stem 32, the adornment is positioned such that its central axis is disposed at an acute angle relative to the central axis of the stem. The adornment 30 is then rotated slightly so that its axis moves toward the axis of the stem 32. This causes pressure on each head 62 and 64 as a result of bearing against the stem 32 to increase, flexing the cradle 36 at least slightly to accommodate the rotation. As a result, each head 62 and 64 slides and rotates slightly moving the point of contact away from the initial point of contact and causing the adornment 30 to snap onto the stem. When mounted in the manner depicted in FIG. 1, a line that extends through the center of both heads is disposed at an acute angle relative to the central axis of the stem 32 and the adornment 30. When mounted on a stem 32, the cradle 36 is helically coiled around the stem 32 at least one complete turn such that the adornment 30 encircles the stem. The adornment 30 preferably snaps onto the stem 32.

When mounted to a stem 32, the adornment self-supports itself in an upright position in the manner shown in FIG. 1, as a result of the selected combination of wire constituents, hardness, diameter and preformed shape. As a result of these criteria and the forming process imparting at least some shape memory to the cradle 36, the adornment 30 can be snapped on and off the stem 32 without significantly deforming the cradle. Preferably, no plastic deformation of the cradle 36 occurs during normal use permitting each adornment 30 to be repeatedly used. Should an adornment 30 somehow become bent or misshapen, it can simply be wrapped tightly around the stem 32 of a piece of stemware 34 to reintroduce a suitable helical or spiral shape to the adornment 30 so that will function as intended once again.

A stemware adornment of the invention clings to the stem of the piece of stemware such that rapid movement, jostling, bumping or the like will not cause the adornment to break free of the stem. Advantageously, construction is more robust and reliable as no closure is needed. The adornment wraps around a stem of the glass in such a manner that it appears to become part of the glass in an aesthetically pleasing manner.

To remove the adornment 30 from the stem 32, the adornment 30 is grasped and rotated in an opposite direction until both heads 62 and 64 clear the stem 32 thereby disengaging the adornment 30 from the stem 32. During rotation, the cradle 36 flexes slightly to permit one or both heads 62 and 64 to clear the stem 32 so as to disengage the adornment 30. Thereafter, the adornment 30 can be stored, such as in the package 70 shown in FIG. 9, for later reuse.

It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

1. An adornment that comprises a generally helical preformed clip that releasably receives one of a napkin and a stem of a stemware.

2. The adornment of claim 1 wherein the generally preformed clip is comprised of a helical segment of wire having a head fixed at each end of the helical segment.

3. The adornment of claim 1 wherein the generally helical preformed clip is comprised of a wire having a thickness of at least eighteen gauge and further comprising a head attached by a non-blooming adhesive to each end of the wire.

4. The adornment of claim 1 wherein the generally helical preformed clip is comprised of a generally helical segment of wire that overlaps one of the napkin and the stem along an axial direction of the one of the napkin and the stem.

5. The adornment of claim 1 wherein the generally helical preformed clip is comprised of a segment of wire that is performed around a cylinder into a generally helical shape to impart a shape memory to the wire such that that the adornment will snap onto the stemware stem.

6. The adornment of claim 1 wherein the generally helical preformed clip is comprised of a segment of shape memory wire that forms a cradle that has a snap fit with the stemware stem.

7. The adornment of claim 1 wherein the generally helical preformed clip is comprised of wire having a diameter of at least 0.045 inches so as to retain its shape memory when formed into a helical segment of wire, and the helical segment of wire circumferentially overlaps along an axial direction when received on the one of the napkin and the stemware stem.

8. The adornment of claim 5 wherein the preformed generally helical clip comprises a generally helical segment having (a) at least one indicia or aesthetically pleasing object carried by the generally helical segment so as to be movable relative thereto, and (b) having a head fixed at each end of the generally helical segment that is larger than the at least one indicia or aesthetically pleasing object.

9. The adornment of claim 5 wherein the preformed generally helical clip comprises a generally helical segment of German jewelry wire having (a) a thickness of at least 0.038 inches, (b) a plurality of beads received on the helical segment of German jewelry wire with each bead movable relative to the helical segment of German jewelry wire, and (b) having a bead fixed at each end of the helical segment of German jewelry wire.

10. An adornment for a stem of a stemware or a napkin comprising:
a helical segment of wire;
a head fixed to each end of the helical segment of wire;
a bead carried by the helical segment of wire and disposed between the ends of the helical segment of wire; and
wherein the helical segment of wire circumferentially overlaps in an axial direction when received on one of a stemware stem and napkin.

11. The adornment of claim 10 wherein the helical segment of wire is comprised of German jewelry wire and each head comprises a bead that is larger than the bead carried by the helical segment of wire and disposed between the ends of the helical segment of wire.

12. The adornment of claim 10 wherein the helical segment of wire is comprised of metallic wire having thickness such that it retains its helical shape after repeated use and the bead and each head is comprised of a colored acrylic material with each head fixed to the helical segment of wire using a low blooming cyanoacrylate adhesive.

13. An adornment removably receiving an object comprising:
a preformed helical segment of wire having a length not more than three inches;
a plurality of spaced apart indicias carried by the helical segment of wire with one of the indicias disposed adjacent one end of the helical segment of wire and the other one of the indicias disposed adjacent the other end of the helical segment of wire; and
wherein the helical segment of wire retains is helical shape after being put onto and taken off of a plurality of times.

14. The adornment of claim 13 wherein the preformed helical segment of wire is comprised of German jewelry wire that is eighteen gauge or thicker and further comprising a low-blooming adhesive disposed between each indicia and the helical segment of wire fixing each indicia thereto.

15. The adornment of claim 13 wherein the preformed helical segment of wire and plurality of indicias form an interference fit with the received object.

16. The adornment of claim 15 wherein the interference fit comprises a snap fit.

17. The adornment of claim 13 wherein the helical segment comprises a cradle and further comprising a head attached to each end of the cradle that bears against the object to help retain the adornment on the object.

18. A method of making an adornment for receiving a stemware stem or napkin comprising:
(a) providing a mandrel, a segment of wire, a plurality of heads, and an adhesive;
(b) forming the wire into a helical segment using the mandrel; and
(c) fixing each one of the plurality of heads to one end of the helical segment using the adhesive.

19. A method according to claim 18 wherein the mandrel comprises a helically grooved mandrel of generally cylindrical construction and the wire is wrapped around the mandrel such that it seats in the helical groove.

20. A method according to claim 18 wherein the wire is of eighteen gauge or thicker, the adhesive comprises a low blooming adhesive, and forming the wire in step (b) comprises wrapping the wire around the mandrel thereby imparting shape memory to the wire such that it retains its generally helical shape after repeated use.

21. An adornment package comprising an adornment carrier of zig-zag cross-section, a panel adjacent the adornment carrier, a bottom in which the adornment carrier and panel are received and a color comprised of a material through which a plurality of adornments received in the adornment carrier are received.
